(19) United States
(12) Patent Application Publication
(10) Pub. No.: US 2011/0287330 A1
(43) Pub. Date: Nov. 24, 2011

(54) HIGH-TEMPERATURE FUEL CELL SYSTEM

(76) Inventors: Sascha Kuehn, Dresden (DE); Katrin Klein, Dresden (DE); Gerhard Buchinger, Wels (AT)

(21) Appl. No.: 12/998,883

(22) PCT Filed: Dec. 11, 2009
(86) PCT No.: PCT/EP2009/008883

§ 371 Date: Aug. 11, 2011

(30) Foreign Application Priority Data
Dec. 11, 2008 (DE) 10 2008 062 617.1

(51) Int. Cl. H01M 8/04; H01M 8/06; H01M 8/24

(52) U.S. Cl. 429/408; 429/512; 429/452; 429/434

(57) ABSTRACT

The invention relates to a high-temperature fuel cell system comprising at least one fuel cell as heat generating source and/or at least one fuel cell system component as exothermic or endothermic source enclosed by a thermal insulation system. Between an inner thermal insulation unit and a radial outer shell at least one hollow space exists and this hollow space is evacuated or at least one fluid can be fed through and/or stored inside of the hollow space.

The invention relates to high-temperature fuel cell systems. In particular, systems for lower output ranges present the problem that high working temperatures (several 100° C.), which are required for the operation, are difficult to achieve due to the small heat quantity generated by the system itself. At the same time, the outside temperature of mobile operated fuel cell systems must be kept very low; this requires special consideration to the thermal insulation. In order to achieve a low outside temperature, a corresponding thick insulation must be applied. At the same time, however, increasing the system's dimensions can mean increased heat losses (even at lower temperatures). Simulations that describe these heat losses demonstrate that even at an outside temperature of 50° C. and an outside diameter of a few centimetres, a critical value can be reached, if the system is operated at an electrical power of several Watts. This is to say, a conflict exists between the required thickness of the insulation and the associated heat emission even at lower temperatures. The losses are the results of thermal conduction, convection and/or radiation. An appropriate complete utilization of the inner system's heat by means of heat exchangers can not be realized, due to the size, complexity and cost. Furthermore, application-related limits are set for the thickness of the insulation and so the final dimensions of the system; this applies in particular to mobile systems.

Fuel cells have long been known as tertiary galvanic elements. Among the various fuel cell types, solid oxide fuel cells (SOFCs) have placed themselves in an excellent position due to the largest flexibility of the fuel.

Due to the high operating temperatures, often higher than 600° C., thermal losses are of vital importance, in particular in smaller systems. This is one of the reasons why the majority of SOFC applications are not designed for smaller mobile and portable systems. However, some approaches were taken considering mobile or at least potentially mobile systems with SOFC by using external burners [C. Finnerty, G. Tompsett, K. Kendall, R. Ormerod; Journal of Power Sources 86 (2000) 459-463 or V. Lawlor, S. Griesser, G. Buchinger, A. Olabi, S. Cordiner, D. Meissner; Journal of Power Sources, 2009, pp. 387-399]. With technical solutions like this and, in particular for small systems with low output, sufficient insulation and/or a high degree of efficiency is difficult to realize since the thermal losses and/or the energy required in order to reach the thermal equilibrium during the starting phase can raise with increasing insulation thickness and the resulting increase in dimensions.

The problem to be solved by the invention comprises the allocation of high-temperature fuel cell systems, in particular low output systems, whereby thermal losses and space requirements are simultaneously reduced and/or the thermal losses are used for the system, whereby an increase in efficiency (no unnecessary exothermal reactions (e.g. combustion) of fuels only for the maintenance of the operating temperature) and/or the reduction of the system's dimensions is realized.

According to the present invention this problem can be solved with a high-temperature fuel cell system exhibiting the features of claim 1. Advantageous embodiments and further developments of the invention can be achieved by means of the features disclosed in subordinate claims.

According to the present invention of said high-temperature fuel cell, at least one fuel cell as heat-generating source and/or at least one fuel cell system component, e.g. reformer, burner and/or evaporator as heat-generating (exothermic) or heat consuming (endothermic) source is enclosed by a thermal insulation system. At least one hollow space exists between the inner thermal insulation unit and the radial outer shell. In one alternative method the hollow space can be evacuated or a fluid can be carried through and/or said fluid can be stored within said hollow space, whereby a heating or cooling effect can be achieved. In particular, a gradual temperature profile between the inner side of the hollow space (inner thermal insulation unit) and the outer side of the hollow space (shell) is preferred. Said shell can be enclosed by another envelope, which performs a protective (e.g. scratch-resistant) or visual function.

It is advantageous to design the radial outer shell of a material exhibiting a low thermal conductivity. An additional insulation layer can be constructed onto the radial outer shell and/or a heat-reflecting coating can be added to the inner wall of said shell. The three options mentioned above can also be realized as a combination with this invention. The insulation layer can also be designed as an evacuated hollow space.

Ideally, media supplied through the hollow spaces into the system can use the temperature level on the inner side of the hollow space to further be heated, which overall leads to a smaller heat loss and/or to a cooler temperature of the shell. If the hollow space is evacuated, it serves as thermal barrier and, due to the high temperature drop between inner thermal insulation unit and outer shell, can therefore lead to a considerably more compact design of the insulation system.

An option exists to design at least two hollow spaces, separated by at least one separating wall, whereby said hollow spaces are located between the radial outer shell and the inner thermal insulation. Dissimilar fluids and/or fluids of different temperatures can be carried through these hollow spaces. By way of example, a cooling effect but also preheating of the fuel or an oxidizing agent can be achieved. Preferably, the separating wall is realized, whereby an (outer) hollow space between shell and separating wall and an (inner) hollow space between separating wall and insulation is created. By way of example, a warmer medium (e.g. exhaust gas of the system that is already pre-cooled by a heat exchanger) flows from the system's interior to the system's exterior inside the inner hollow space and a cooler medium flows from the system's exterior to the system's interior in the outer hollow space (e.g. supplied cathode air) thus, generating an additional cooling effect upon the outer shell. Caused by the heat transfer between the media of the outer and inner hollow space, the system's thermal loss to the outside can be decreased. It is important to emphasize the fact that in this embodiment the heat of the exhaust gas can be utilized with an energy level, which otherwise will be accepted as a loss in a single-stage heat exchange system and, while at the same time the heat emission of the inner insulation can be utilized through the inflowing medium and its warming-up in the outer hollow space.

Additional gas channels can be carried through the thermal insulation unit up to at least one fuel cell and/or at least one other system component (e.g., heat exchanger, reformer, afterburner) whereby it is most advantageous to arrange these system components/fuel cells such that the components' temperature drops towards the outside of said system. Preferably, this can be achieved by using at least one heat exchanger that encloses the hot system components and a medium flowing through the heat exchanger from the system's exterior to the system's interior and said medium absorbing the heat which can be further converted in the system. Preferably, the heat exchanger is designed, whereby the media supplied from the outside is warmer in the section closer to the interior of the system than in the section closer to the shell of said system. The exterior of the heat exchanger is then enclosed by an inner thermal insulation unit, which in turn and according to this invention is enclosed by at least one hollow space. In a special configuration of the present invention condensation of the water vapour that was generated inside of the fuel cell system occurs in the hollow space divided by a separating wall on the side of the exhausting gas (e.g. on the outside of the hollow space between separating wall and shell). This can be achieved by means of an appropriate temperature control system of the apparatus. By way of example this can be achieved by adjusting the volume of the inflowing cold media on the opposite side of the separating wall, through the thickness of the outer and/or inner insulation, by adjusting the generated heat within the system, and adjusting the heat transfer surface between the inner and outer hollow spaces of the insulation unit. By means of this condensation the condensation heat is transferred to the inflowing media, which in turn can increase the overall efficiency of the system.

According to the present invention of a high-temperature fuel cell system one or several fuel cell(s) can be directly enclosed by a system that is designed for the heat exchange, or said system can be located directly next to the fuel cell(s). Furthermore, said system can be characterized in that some or all heat-generating and/or heat consuming components (e.g., burner, reformer and fuel cells) are directly enclosed by a system that is designed for the heat exchange, or said system can be located directly next to these components. Within a preferred embodiment a combination of heat exchangers with one or several fuel cell system components takes place in one common component of said system. By way of example, this may occur if two channels are placed next to each other inside the heat exchanger or at least thermally communicating channels are available and one or both said channels are equipped with catalytically active material for reforming or catalytic combustion. Preferably, one channel absorbs heat (e.g. endothermic fuel reforming) and one channel emits heat (e.g. combustion).

A reducing gas/gas mixture (e.g. fuel) for the operation of a fuel cell(s) and/or at least for one fuel cell system component (e.g. reformer and/or burner), an oxidizing gas and/or an exhaust gas from fuel cells and/or at least from one fuel cell system component (e.g. afterburner) can be directed through one hollow space or several hollow spaces. Especially dissimilar gases should be moved through the different hollow spaces/channels.

The design of an insulating unit can comprise several layers. Inflowing gas can be passed through the system between the layers, whereby said gas can dissipate the dropping heat from the insulation in a beneficial way, preferably into the system interior of the fuel cells. Another preferred variant is characterized by that the dissipated heat is utilized to increase the vapour pressure of a fluid (e.g. liquid gas, alcohols) or said heat is utilized to increase the pressure of a stored gas. This can be implemented by routing the medium (e.g. air), which absorbs the heat of the inner insulation layer, through the hollow space and to a reservoir that is filled with fluid or gas, heating said fluid or gas. However, the hollow space itself can also completely or partially be filled with said fluid. Preferably, said fluid is used for the operation of the fuel cell system. If this fluid is expanded in order to operate the system and is thereby transferred into its gaseous state (e.g. by opening a shut-off valve of the reservoir) an outward cooling effect, due to the evaporation or vaporisation heat, occurs again, which can lead to a lower shell temperature thus, making it possible to reduce the size of the system. As an alternative all or individual hollow spaces/gaps can be evacuated to minimize the heat transfers.

A medium can also be passed through the hollow space and said medium can be utilized only to cool the surrounding shell. In a special embodiment the cooling medium is ingested into the system by means of depression-generating elements, e.g. a venturi nozzle and/or a jet pump, whereby said venturi nozzle and/or said jet pump can be connected to a hollow space. An even more sophisticated embodiment utilizes a venturi nozzle/jet pump to ingest in the medium (e.g. air), whereby said venturi nozzle/jet pump generates a vacuum due to the exhaust gas flowing out of the system. Alternatively, the outflowing exhaust gas can used to drive a compressor, and where said compressor can supply the air to the hollow space (e.g. via the turbocharger principle). Preferably, the exhaust gas of the fuel cell system is to be mixed with the medium that passes through the hollow space, whereby an additional cooling effect as well as a dilution of the exhaust gas occurs. By way of example, said dilution can prevent an impermissible concentration of pollutants in the exhaust gas and/or said dilution can prevent an undesirable concentration of water to prevent condensation, which is generated in the fuel cell system. An option is presented to apply a layer of heat emitting (reflecting) coating to the inside and/or outside of the outer insulation layer and/or the inside and/or the outside of the most inner insulation layer.

A hollow space/gas chamber located between the shell and the interior of the thermal insulation unit can have at least one separating wall thus, allowing the transmission of dissimilar gases past said separating wall.

Heated exhaust gas of the system can be carried through the inner separation (divided hollow space) of the gas chamber, while cold gas can be passed through the outer separation (divided hollow space) of said gas chamber or vice versa.

Gas channels for cooling of the system can be present inside the thermal insulation unit. Gases (e.g. air, oxygen or any other oxidizing gas) can be carried through said gas channels inside said insulation layer. Clean air, pure oxygen or any other clean oxidizing gas or fresh oxidizable gas, e.g. hydrogen, propane, n-butane, isobutene, reformat, reforming gas mixtures or methane can be used as inflowing gas entering the system. The respective used exhaust gases can be utilized as outflowing gases. Other fluids such as hydrocarbon, alcohols, ammonia or ether as well as mixtures of the preceding fluids can be used as inflowing and outflowing media.

This invention is advantageous for the use with tubular SOFCs and preferred in particular for microtubular SOFCs. Certain fibres of a ceramic material can be utilized as insulation material of the thermal insulation. The fibres can be compressed into another and/or joined by means of other joining methods e.g. bonding, whereby fibres from aluminium oxide, magnesium oxide, calcium oxide or zirconium oxide are preferred. Furthermore, so-called aerogels, plastics, ceramic or mineral-type insulations (e.g. aluminium oxide, magnesium oxide, calcium oxide or zirconium oxide), wool, cork and/or evacuated materials (e.g. so-called vacuum insulation panels) can be used as insulation materials.

A multi-layer insulation can also be applied, whereby several material characteristics can be combined. By way of example, a material with low thermal stability can be applied directly on top of an insulation layer characterized by high thermal stability. This is preferred, in particular, if said material with low thermal stability exhibits a better insulation effect, especially at low temperatures and/or said material is available at a more favourable rate and/or said material is less brittle thus, provides a better absorbability and/or said material offers a better stability in case of vibrations and/or in case of impact. It is further possible that the material inside one hollow space or several hollow spaces, which is/are located between two layers of insulation, comprises a multi-layer insulation unit applicable to this invention and that said insulation unit comprises a temperature-stable material other than that outside of the hollow space or outside several hollow spaces.

Also possible within the scope of the invention is a fuel cell system characterized in that said inner insulation unit consists of a composite material with one component having its melting point or melting region close to the targeted operating-temperature (particularly between 500 and 1000° C.). One positive effect would be that in case of reaching a certain temperature heat is consumed by the melting of this component which increases the safety of the system.

Another possibility within the scope of the invention is a high-temperature fuel cell system characterized that the fluid fed through the hollow space is fed to a chiller or a peltier-element to actively prevent peripherical-parts like accumulators or the shell-surface from overheating. Such peripherical parts could also be valves, electronic components (e.g. charging devices for the accumulators, controlling devices, sensors, voltage transformer, fuel tank and housing).

The following designs are given by way of example to illustrate the invention.

The accompanying drawings show:

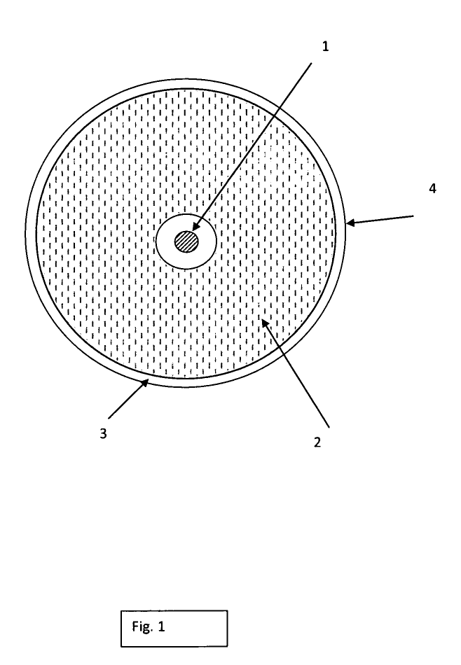

FIG. 1 shows a cross-section of the system comprising fuel cell or fuel cell stack to which the present invention relates;

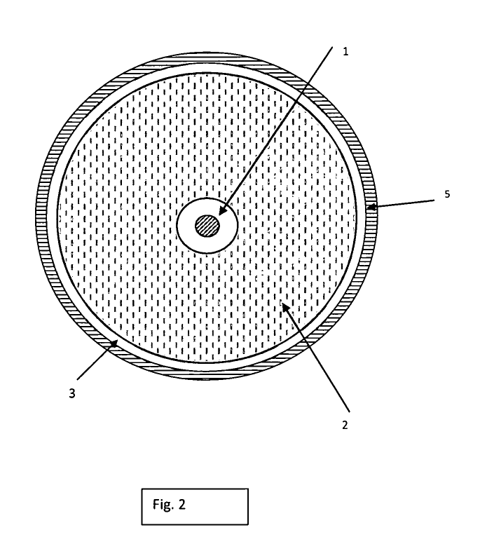

FIG. 2 a further example of the system to which the present invention relates;

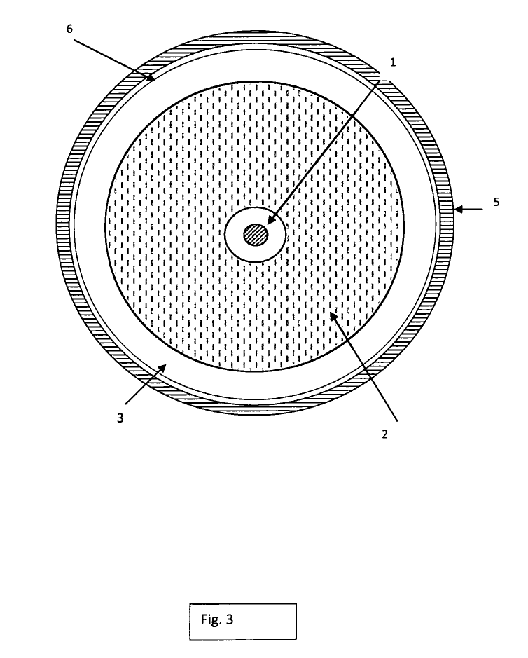

FIG. 3 a further example of the system to which the present invention relates;

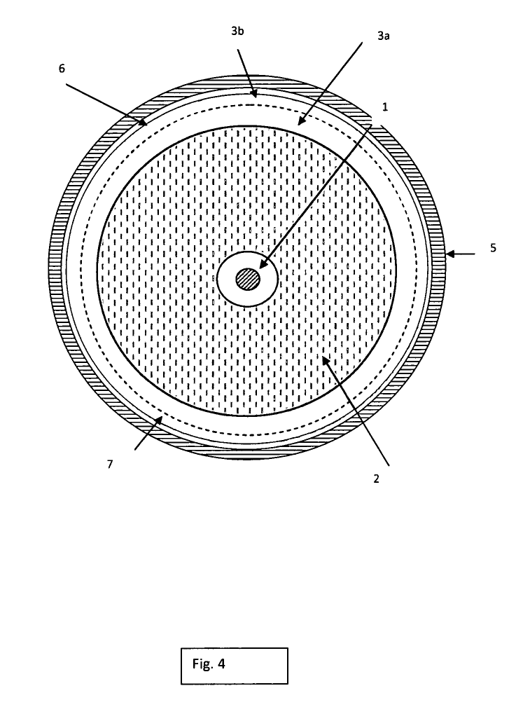

FIG. 4 a further example of the system to which the present invention relates;

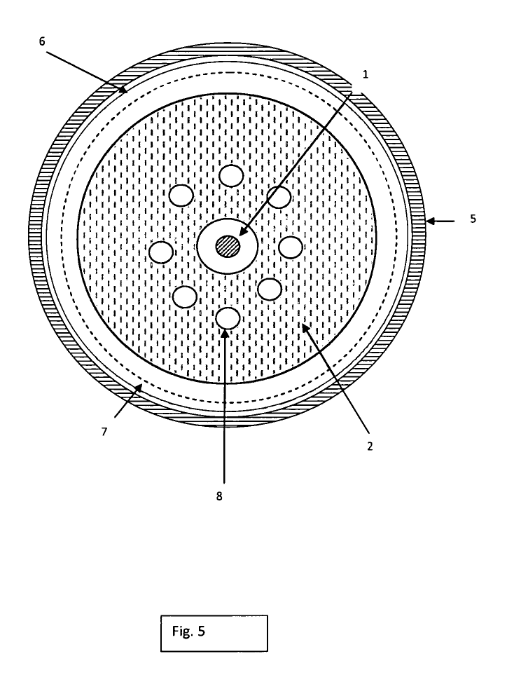

FIG. 5 a further example of the system to which the present invention relates;

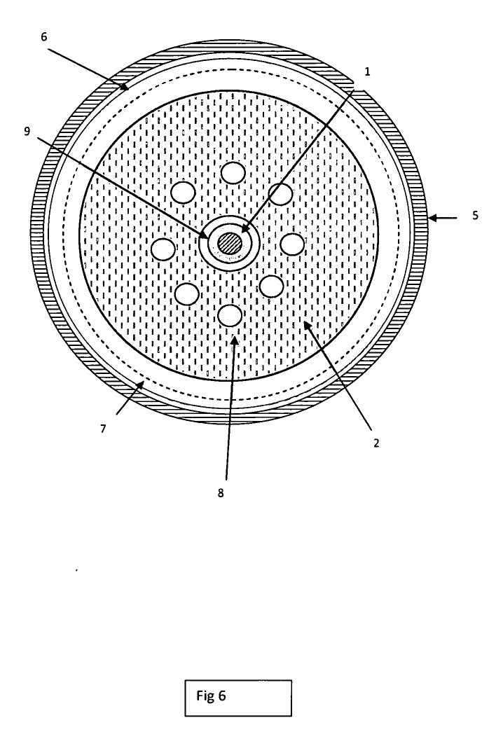

FIG. 6 a further example of the system to which the present invention relates;

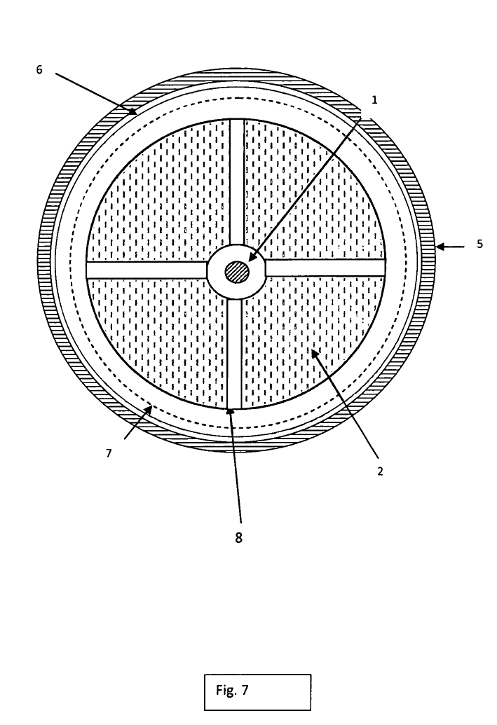

FIG. 7 a further example of the system to which the present invention relates;

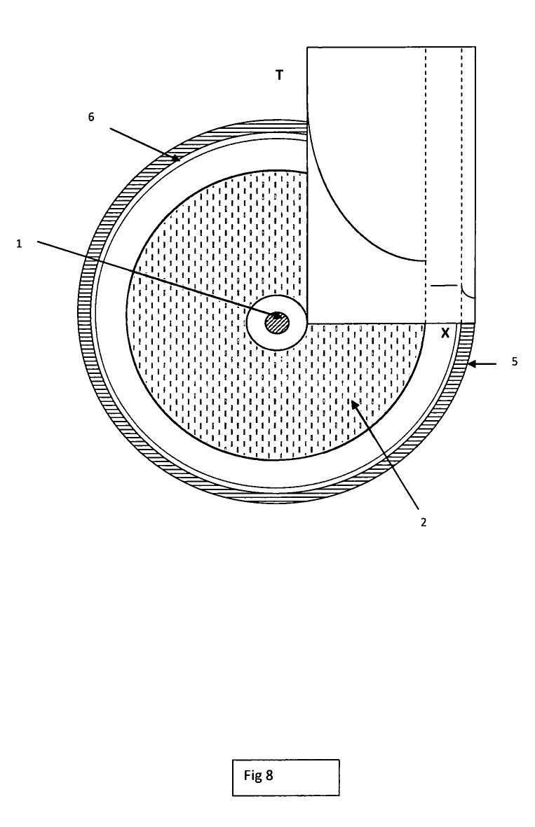

FIG. 8 schematic of a temperature profile;

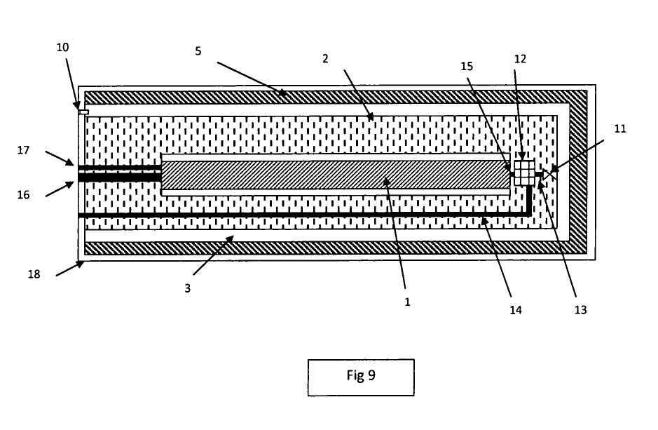

FIG. 9 a further example of the system to which the present invention relates;

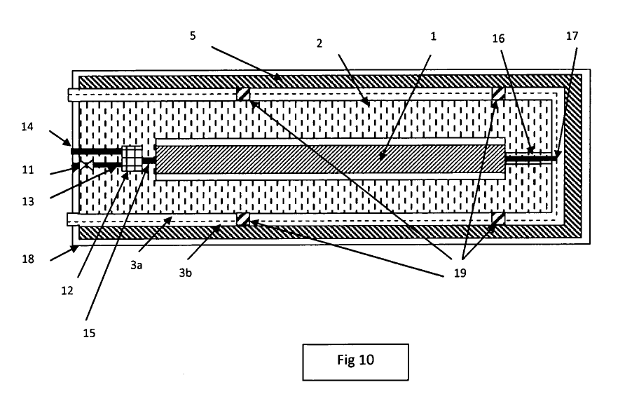

FIG. 10 a further example of the system to which the present invention relates;

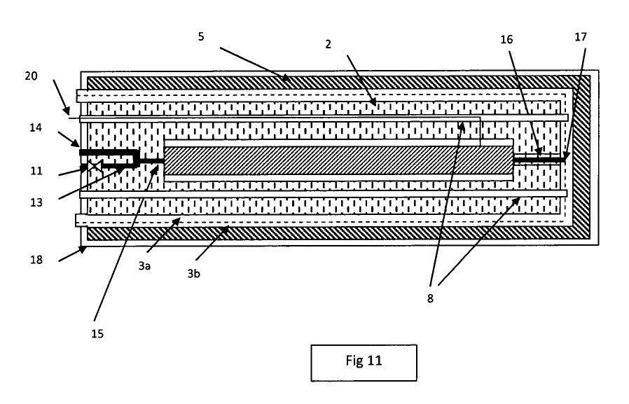

FIG. 11 a further example of the system to which the present invention relates;

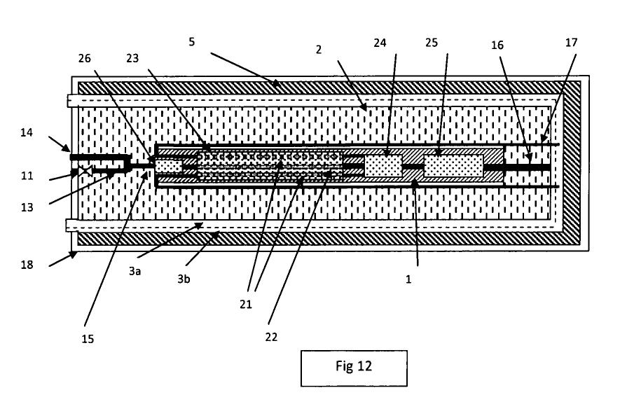

FIG. 12 a further example of the system to which the present invention relates;

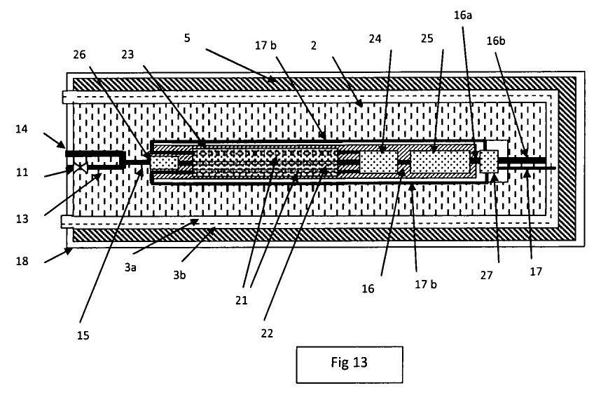

FIG. 13 a further example of the system to which the present invention relates and

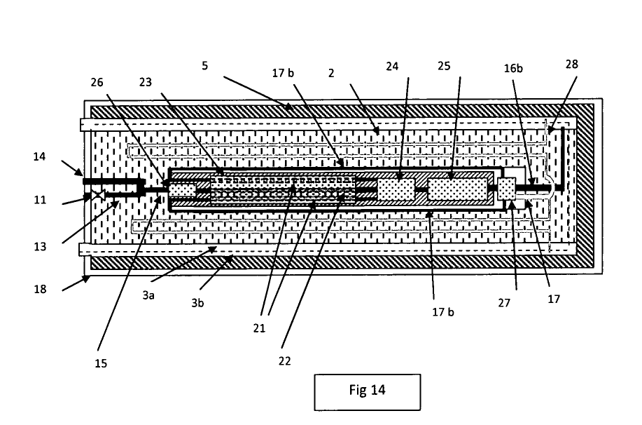

FIG. 14 a further example of the system to which the present invention relates.

FIG. 1 shows a cross-section of a system comprising a fuel cell 1 or a fuel cell stack as heat-generating source and/or other hot system components, which are hotter than the surroundings of fuel cell 1. Fuel cell 1 or a fuel cell stack is a microtubular SOFC or constructed of microtubular SOFCs, respectively. Fuel cell 1 or a fuel cell stack is enclosed by an inner thermal insulation unit 2. Said thermal insulation unit 2 is enclosed by a radial outer shell 4, whereby said outer shell 4 serves to reduce the thermal losses. Gas flows into the system through hollow space 3, whereby said hollow space 3 is located between outer shell 4 and thermal insulation 2 and the heat emitted from the outer wall of insulation unit 2 is transmitted into the system—mainly through convection—thus, reducing the thermal losses. Alternatively, said hollow space 3 can also be evacuated, which also leads to a reduction of the thermal losses.

Analogue FIG. 1, and by way of example, in FIG. 2 is shown an outer shell 5 comprising an addition insulation layer consisting of a poor thermal conductive material, whereby said layer can also be an evacuated space.

Analogue and by way of example according to FIG. 2, FIG. 3 shows an additional heat-reflecting layer 6 applied to the inside of outer shell 5, whereby heat-reflecting layer 6 reduces the heat losses by means of heat emission.

By way of a separating wall 7, hollow space 3 can be divided into two hollow spaces 3a and 3b as shown by way of example in FIG. 4. This allows a gas to be carried through the radial inner hollow space 3a, preferably said gas is dissimilar to the gas which is to be carried through the radial outer hollow space 3b, or alternatively said hollow spaces can be evacuated. Preferably, warmer gas flows through the radial inner hollow space 3a and out of the system, and cooler gas flows through the outer hollow space 3b into the system. Hollow space 3 can be divided into more than two hollow spaces 3a and 3b. Separating wall 7 can be designed whereby a partial mixing (1-99%) of the media inside of hollow space 3a and 3b is possible.

By way of example, the inventive system according to FIG. 5 shows additional gas channels 8 inside the inner thermal insulation 2, whereby said gas channels can be utilized for the thermal management for cooling or heating of the system. Preferably, the gas flowing into the system will be heated further, and as a result further cooling of the exterior occurs, and whereby the thermal losses are reduced caused for example due to thermal conduction inside of the insulation. By way of example, said gas channels 8 can be drilled into the insulation block. Furthermore, the inner insulation unit 2 can be wrapped around gas channels 8, said insulation unit 2 can be sprayed on or applied in any other way to said gas channels 8.

The insulation layer of shell 5 can also comprise said gas channels 8.

By way of example, FIG. 6 shows an additional heat-exchanging system 9 which encloses fuel cell (s) 1 as a heat-generating source and whereby said additional heat-exchanging system 9 contributes to the thermal management. Said heat-exchanging system 9 can be a heat exchanger, a burner—in particular a catalytic porous burner—and/or a reforming component. Another preferred embodiment is characterised by that the heat-generating source comprises one or several microtubular SOFCs, whereby the heat-exchanging system 9 is a heat exchanger and the medium supplied to said system 9 is heated, which reduces the sum of all thermal losses of the overall system. Any combination of the above-mentioned or any other heat-exchanging system can be used for the present invention.

By way of schematic representation, FIG. 7 shows one example of the present invention whereby the gas channels 8 inside of insulation unit 2 are arranged not parallel but vertical to the heat-generating source (fuel cell 1). Gas channels 8 can be applied as strips along the entire insulation unit 2 or said channels 8 can be inserted as depth-limited bore.

By way of schematic, FIG. 8 shows a possible temperature profile of an insulation according the present invention. At the beginning, and moving from the inside to the outside, the temperature gradient is very pronounced across the thickness of insulation unit 2, however, the temperature gradient is strongly flattening thereafter. Hollow space 3, located between insulation unit 2 and shell 5 and the gas flowing through said hollow space 3 cause a gradual non continuous temperature drop. Based on the lower temperature the insulation of shell 5 can be made of another material characterised by a lesser thermal conductivity but reduced thermal stability.

FIG. 9 shows another inventive embodiment of this fuel cell system. In this case the hollow space 3 is filled with fuel such as liquid gas. The (vapour) pressure of the fuel (e.g. hydrogen as hydride, liquid alcohols, liquid gas) stored inside the hollow space is increased by means of the fuel cell system's waste heat. Said fuel is pumped into the system using filler pipe 10. The fuel is fed to a venturi nozzle/jet pump 12 via a valve 11, which is lockable and preferably controllable, and whereby the fuel is released through said valve preferably in a gaseous stage. Due to the fuel, preferably pressurized, jet pump 12 ingests the air via pipe 14 and supplies the generated air/fuel mixture to the fuel cell(s) 1 of the fuel cell system via pipe 15. Air is supplied to the fuel cell system's cathodes via pipe 17, whereby said air can be supplied via a jet pump/venturi nozzle or actively supplied via a pump, if necessary. The waste gas of the fuel cell(s) 1 is subsequently conducted via pipe 16. Preferably, pipes 17 and 16 exchange heat intensively. 18 describes a housing of the fuel cell system, characterized by also enclosing outer shell 5. According to the present invention, housing 18 is preferably designed of impact-resistant material and/or attached for visual effects.

FIG. 10 shows a longitudinal section of the system, comparable to FIG. 4. The cathode air is supplied to the inner fuel cell(s) 1 via the outer hollow space 3b. By way of example, in this case the air is supplied via pipe 17, whereby said pipe 17 is in intensive heat exchange with pipe 16. Additional heat-exchanging components can be integrated. The waste gas is conducted through hollow space 3a, whereby said waste gas exchanges heat with the medium in hollow space 3b. In this case in particular, and according to the present invention, the gas in hollow space 3b passes through the system whereby said gas preferably circulates thermal bridge 19 between the exterior of insulation unit 2 and the outer shell 5, contributing to a cooling effect, or said gas carries the absorbed heat into the system. Thermal bridge 19 represent materials/components which are necessary for structural reasons, e.g. for a rigid mechanical design and/or as the system's power tap, but overall said thermal bridges 19 cause a poor insulating effect and therefore can potentially reduce the efficiency of the system. Preferably, these materials are made of poor thermal conductive substances and/or said materials are designed with a large specific surface—in particular in hollow space 3b—in order to provide an intensive heat exchange with the medium supplied to the system. By way of example, a possible embodiment can be porous gas-permeable structures of the thermal bridge 19.

FIG. 11 shows a longitudinal section of a possible arrangement of gas channels 8, located in the interior of insulation unit 2. In this embodiment jet pump 12 is not used to supply air to the fuel. To do this, a electrically or mechanically driven pump (not shown) can be utilized. In this graphical representation, electrical contacts 20 of the fuel cell system are used, but due to their often metallic features they potentially work as thermal bridges. Said bridges are cooled by the cooling medium (e.g. air) entering the gas channels 8 and so most of the heat emitted by said bridges flows through the medium in gas channel 8 and back into the system.

By way of example, FIG. 12 shows the cooling media drawn in via a jet pump 24. In this case the medium is air and said air is ingested through the outer hollow space 3b via the jet pump/venturi nozzle whereby said jet pump/venturi nozzle generates the necessary vacuum through the anode exhaust gas of the fuel cell(s) 23. In this example at least one air pipe 21 of the cathode(s) of one/several fuel cell(s) and at least one respective anode pipe 22 are available. In this special embodiment, a reformate that is useable in the fuel cell is generated in reformer 26. Reformer 26 is fed from a pipe 13 with a medium (e.g. fuel) having a reducing effect and a pipe 14 with a medium (e.g. air, water vapour) having an oxidizing effect. The exhaust gas of fuel cell unit 23 is passed on to the venturi nozzle/jet pump 24 which ingest the cathode air through this medium. In a down-stream reactor (e.g. afterburner) 25 this medium is further chemically converted. Preferably, the exhaust gas in pipe 16 will be cooled down by the inflowing media in pipe 17. This can be achieved by means of a respective heat exchanger, whereby pipe 16 and 17 are arranged immediately next to each other. Preferably, the medium in pipe 17 can further remain with reformer 26 in heat exchange.

FIG. 13 describes an example that is similar with the system described in FIG. 12. In this embodiment at least one additional separate heat exchanger 27 is installed in the fuel cell system. In this system the exhaust gas of afterburner 25 is passed through heat exchanger 27 and the heat is transferred to the media coming from hollow space 3b. The medium coming from the afterburner 25 through pipe 16a is cooled, while the medium coming from hollow space 3b through pipe 17 is heated. Subsequently, the cooled exhaust gas is passed through pipe 16b into hollow space 3a. The heated medium from hollow space 3b (e.g. air) is fed via pipe 17b to the cathode chamber 21 of the fuel cells; through this an additional heat exchange with reformer 26 takes place. In a preferred embodiment an intensive heat exchange between the media in pipe 17 and 16b takes also place. This can be achieved via the spatial proximity of pipe 17 and 16b. A preferred embodiment combines at least one additional system component and heat exchanger 27 in a single component. By way of example, this would apply to heat exchanger 27 having two separate flow channels, whereby the medium (e.g. cathode air) from hollow space 3b flows in one flow channel and another component having a reforming effect is contained in the other flow channel, and there the reforming of the media from pipe 15 takes place. Instead of or in addition to the integration of reformer 26, the integration of afterburner 25 would be a preferred variant. By way of example, heat exchanger 27 could be a tube bundle heat exchanger, a plate heat exchanger, a spiral tube heat exchanger, a heat exchanger using rotating flow channels (APH—air preheater principle) between the various media and/or a column tube heat exchanger. The gas chambers of the media, from which said media flow into hollow space 3b or flow out of hollow space 3a respectively, are flow-specifically in their entirety or at least in part separated from each other thus, preventing a total mixture or at least limiting the mixture (1-99%).

FIG. 14 shows a system comparable with FIG. 13. In this case hollow space 3 is only attached to the longitudinal surface of insulation unit 2. In this case the medium flows out of hollow space 3b via pipe 28 through insulation unit 2 and is fed into heat exchanger 27.

In this example one additional side of insulation unit 2 is not enclosed by hollow space 3. In a fuel cell system whereby hollow space 3 totally encloses insulation unit 2, the necessary outlets (e.g. pipes 14, 11) can be passed through hollow space 3 and said pipes 14, 11 would be thermal bridges like 19. Parts of hollow space 3 can be designed by that at least one medium passes through hollow space 3 and other parts can serve as reservoir for the fuel or said parts can be evacuated.

1. A high-temperature fuel cell system comprising at least one fuel cell as heat generating source and/or at least one fuel cell system component (25, 26) as exothermic or endothermic source, enclosed by a thermal insulation system, and wherein between an inner thermal insulation unit (2) and a radial outer shell (4, 5) at least one hollow space (3) exists and this hollow space (3) is evacuated or at least one fluid can be fed through and/or stored inside of the hollow space (3).

2. A high-temperature fuel cell system in accordance with claim 1, characterized in that said radial outer shell (4, 5) whereby said radial shell is made from a material with low thermal conductivity and/or an additional insulation unit (2) is constructed onto said shell (4, 5).

3. A high-temperature fuel cell system in accordance with claim 2, characterized in that a heat-reflecting layer is attached to an inner and/or outer wall of the shell (4, 5).

4. A high-temperature fuel cell system in accordance with claim 1, characterized in that said inner insulation unit (2) is a passive thermal insulation unit and, in particular, an evacuated hollow space.

5. A high-temperature fuel cell system in accordance with claim 1, characterized in that between said radial outer shell (4, 5) and inner thermal insulation unit (2) at least two hollow spaces (3a, 3b) are present, which are divided by at least one separating wall (7).

6. A high-temperature fuel cell system in accordance with claim 5, characterized in that different fluids and/or fluids of different temperatures can be fed through said hollow spaces (3a, 3b).

7. A high-temperature fuel cell system in accordance with claim 1, characterized in that gas channels (8) are passed through the interior of the thermal insulation unit (2) and the gas channels (8) dividing said thermal insulation unit into several layers and/or areas.

8. A high-temperature fuel cell system in accordance with claim 7, characterized in that the layers and/or areas are made of different materials.

9. A high-temperature fuel cell system in accordance with claim 1, characterized in that one or several fuel cell(s) (1) and/or at least one of the fuel cell system components (25, 26) are directly enclosed by a system (9), which is designed for the heat exchange; or such a heat exchanging system (9) is located immediately next and/or connected by fluid flow to the fuel cell(s) (1) and/or the at least one fuel cell system component (25, 26) and said system (9) is arranged within the inner thermal insulation unit (2).

10. A high-temperature fuel cell system in accordance with claim 1, characterized in that a reducing fluid or fluid mixture for the operation of the fuel cell(s) (1) and/or the fuel cell system components (25, 25) is fed through the hollow space/spaces (3, 3a, 3b).

11. A high-temperature fuel cell system in accordance with claim 1, characterized in that an oxidizing fluid or fluid mixture for the operation of the fuel cell(s) (1) and/or the fuel cell system components (25, 25) is fed through the hollow space/spaces (3, 3a, 3b).

12. A high-temperature fuel cell system in accordance with claim 1, characterized in that the exhaust gas of the fuel cell(s) (1) and/or the fuel cell system components (26, 25) is fed through the hollow space/spaces (3, 3a, 3b).

13. A high-temperature fuel cell system in accordance with claim 7, characterized in that the heat exchanging system (9) and at least one of the fuel cells (1) and/or fuel cell components (25, 26) are manufactured as one component.

14. A high-temperature fuel cell system in accordance with claim 1, characterized in that at least one hollow space (3, 3a, 3b) is connected to a depression-generating element, in particular a jet pump and/or a venturi nozzle (24).

15. A high-temperature fuel cell system in accordance with claim 1, characterized in that one fuel cell system component is a burner (25) or a reformer (26).

16. A high-temperature fuel cell system in accordance with claim 1, characterized in that said inner insulation unit (2) consists of a composite material with one component having its melting point or melting region close to the targeted operating-temperature.

17. A high-temperature fuel cell system in accordance with claim 1, characterized that the fluid fed through the hollow space (3) is fed to a chiller or a peltier-element to actively prevent peripherical-parts like accumulators or the shell-surface from overheating.
